(19) United States
(12) Patent Application Publication
(10) Pub. No.: US 2021/0291495 A1
(43) Pub. Date: Sep. 23, 2021

(54) FILM FOR GLASS LAMINATION AND METHOD FOR PREPARING SAME

(71) Applicant: SKC Co., Ltd., Suwon-si (KR)

(72) Inventors: Hyejin KIM, Suwon-si (KR); Haksoo LEE, Suwon-si (KR)

(73) Assignee: SKC Co., Ltd., Suwon-si (KR)

(21) Appl. No.: 17/340,364

(22) Filed: Jun. 7, 2021

Related U.S. Application Data
(63) Continuation of application No. PCT/KR2019/010298, filed on Aug. 13, 2019.

(30) Foreign Application Priority Data
Dec. 10, 2018 (KR) 10-2018-0157930

(51) Int. Cl. B32B 17/10; C08J 5/18; C08F 18/10; C08K 5/098; C08K 5/103; C08K 5/3475; B32B 27/22; B32B 27/30; B29C 48/00; B29C 48/08; B29C 71/00; B29C 48/30

(52) U.S. Cl. CPC B32B 17/10688; B29K 2029/14; C08F 18/10; C08K 5/098; C08K 5/103; C08K 5/3475; B32B 17/10036; B32B 17/10761; B32B 27/22; B32B 27/30; B29C 48/022; B29C 48/08; B29C 71/0081; B29C 48/30; C08J 2331/02; C08K 2201/014; B32B 2250/03; B32B 2250/40; B32B 2315/08; B32B 2329/06; B32B 2419/00; B32B 2605/08; B32B 2605/006; C08J 5/18

(57) ABSTRACT

The film for glass lamination of the present disclosure comprises a polyvinyl acetal resin, a plasticizer, and a metal salt, wherein the film has an adhesion control effect of 8.5 kgf/cm² or more per the metal salt in an amount of 10 ppm based on a total weight of the film.

### CROSS-REFERENCE TO RELATED APPLICATIONS

Pursuant to 35 USC 120 and 365(c), this application is a continuation of International Application No. PCT/KR2019/010298 filed on Aug. 13, 2019, and claims the benefit under 35 USC 119(a) of Korean Application No. 10-2018-0157930 filed on Dec. 10, 2018, in the Korean Intellectual Property Office, the entire disclosures of which are incorporated herein by reference for all purposes.

### BACKGROUND

### 1. Field

The present disclosure relates to a film for glass lamination and a method of preparing the same.

### 2. Description of the Background

In general, laminated glass (e.g., tempered glass and safety glass) consisting of a pair of glass panels and a synthetic resin film inserted therebetween is widely used for window glass in road vehicles such as automobiles and buildings due to its enhanced safety because its fragments are not scattered even when the laminated glass is broken. In some cases, a polyvinyl acetal resin having a high affinity for inorganic materials is utilized in the film applied to such laminated glass.

A laminated glass including a film placed between a pair of glass panels has basic properties required, such as penetration resistance and anti-scattering of glass fragments, but moisture resistance of the laminated glass may be degraded, and in this case, an interlayer of the laminated glass may generate a whitening phenomenon in the periphery when in direct contact with an air in a humid atmosphere. Therefore, an additive for adjusting adhesive strength between a film and a glass is used to prevent such whitening phenomenon or the like.

Japanese Patent Publication No. 1998-139496 (application No. 1996-290261) discloses a film, which is used as an interlayer for a laminated glass, whose whitening is not generated, and which contains a polyvinyl butyral, a plasticizer, a carboxyl metal salt, and a denatured silicon oil. However, the film may lower compatibility with a polyvinyl butyral resin due to use of a denatured silicon oil having a low polarity such that a haze value of the final film may be increased, and a functional group of a glass to react with a hydroxyl group of the polyvinyl butyral resin is disturbed by the denatured silicon oil to lower adhesion thereby degrading penetration resistance and impact resistance.

Additionally, if an additive is applied in an excessive amount for an adhesion control effect, moisture resistance is lowered instead, and yellowing index may be increased in long term durability evaluation.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a film for glass lamination includes a polyvinyl acetal resin, a plasticizer, and a metal salt, wherein the film has an adhesion control effect of 8.5 kgf/cm² or more per the metal salt in an amount of 10 ppm based on a total weight of the film.

The film may have the adhesion control effect of 8.5 to 50 kgf/cm² per the metal salt in an amount of 10 ppm based on the total weight of the film.

The film for glass lamination may have an uneven concentration gradient of the metal salt such that a surface of the film includes the metal salt or metal ions derived from the metal salt in a higher concentration compared to a center of the film.

The film for glass lamination may have an adhesion control effect of 1.3 times greater compared to a reference film not having the uneven concentration gradient of the metal salt.

The film for glass lamination may contain a greater amount of the metal salt or the metal ions in both surfaces of the film compared to the center of the film.

The metal salt may be included in an amount of 200 ppm or less based on the total weight of the film.

The metal ion comprised in the metal salt may be selected from the group consisting of sodium (Na) monovalent cation, magnesium (Mg) divalent cation, and potassium (K) monovalent cation.

The metal salt may be a benzotriazole-based compound.

The film for glass lamination may have a yellowing index variation of 2.5 or less between before and after being kept for two weeks in chamber having a constant temperature and humidity of 65° C. and 95% rh.

The film for glass lamination may have a thickness of 0.4 mm or more.

In another general aspect, a method of manufacturing a film for glass lamination includes: preparing a molten resin by melting a composition including a polyvinyl acetal resin, a plasticizer, and a metal salt; and forming the film by applying a voltage to at least a part of a shaping unit for discharging and shaping the molten resin into the film, wherein the film has an adhesion control effect of 8.5 kgf/cm² or more per the metal salt in an amount of 10 ppm based on a total weight of the film.

The film may have the adhesion control effect of 8.5 to 50 kgf/cm² per the metal salt in an amount of 10 ppm based on the total weight of the film.

The film for glass lamination may have an uneven concentration gradient of the metal salt such that a surface of the film includes the metal salt or metal ions derived from the metal salt in a higher concentration compared to a center of the film.

The metal salt may be included in an amount of 200 ppm or less based on the total weight of the film.

The metal ion comprised in the metal salt may be selected from the group consisting of sodium (Na) monovalent cation, magnesium (Mg) divalent cation, and potassium (K) monovalent cation.

The metal salt may be a benzotriazole-based compound.

The voltage applied may be 8 kV or less.

The shaping unit may include an outlet, die lips in both sides of the outlet, and a voltage applying part disposed in the die lips.

The voltage applied in the forming may move the metal ions included in the molten resin to a surface of a discharged molten resin and thereby form the uneven concentration gradient of the metal salt.

In still another general aspect, a laminated glass includes the film for glass lamination disposed between two glasses.

Other features and aspects will be apparent from the following detailed description and the claims.

### BRIEF DESCRIPTION OF THE DRAWINGS

FIG. 1 is a schematic diagram for illustrating a structure of the die lip in the device for regulating an ion concentration of a surface of a film applied according to one embodiment of the present disclosure.

FIG. 2 is a schematic diagram for illustrating the method of measuring a whitening occurrence distance measured according to one embodiment of the present disclosure.

FIG. 3 is a conceptual view for illustrating the device for CSS adhesion evaluation according to one embodiment of the present disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of this disclosure. Hereinafter, while embodiments of the present disclosure will be described in detail with reference to the accompanying drawings, it is noted that examples are not limited to the same.

Throughout the present disclosure, the phrase that a certain element “comprises” or “includes” another element means that the certain element may further include one or more other elements but does not preclude the presence or addition of one or more other elements, unless stated to the contrary.

Throughout the present disclosure, when a composition is “connected” to another composition, this includes not only ‘directly connected’ but also ‘connected with another composition in the middle.’

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

Throughout the present disclosure, the phrase “combination(s) thereof” included in a Markush-type expression denotes one or more mixtures or combinations selected from the group consisting of components stated in the Markush-type expression, that is, denotes that one or more components selected from the group consisting of the components are included.

Throughout the present disclosure, terms such as “first,” “second,” “A,” or “B” are used to distinguish the same terms from each other. The singular forms “a,” “an,” and “the” include the plural form unless the context clearly dictates otherwise.

In the present disclosure, the term “X-based” may mean that a compound includes a compound corresponding to X, or a derivative of X.

In the present disclosure, “B being placed on A” means that B is placed in direct contact with A or placed over A with another layer or structure interposed therebetween and thus should not be interpreted as being limited to B being placed in direct contact with A, unless the description clearly dictates.

In the present disclosure, ppm is calculated based on weight.

In the present disclosure, a singular form is contextually interpreted as including a plural form as well as a singular form unless specially stated otherwise.

The object of the present disclosure is to provide a film for glass lamination with enhanced durability.

The film for glass lamination of the present disclosure can provide a film for glass lamination easy to adhesion control and improved in moisture sensitivity by letting concentration of a metal salt has a gradient from a surface of a film for glass lamination in a thickness direction.

The inventors of the present invention have recognized that, when a metal salt compound is applied in a comparatively large amount, yellowing phenomenon easily occurs, and in a process of conducting research for solving the problem, have verified a method which can regulate an adhesion control effect though an adhesion regulator even though a similar amount is applied, or can regulate adhesive strength effectively even though a less amount is applied, and thus completed this invention. The inventors of the present invention have recognized that, when voltage is applied in a manufacture process of a film and thereby a film is manufactured to have a metal ion concentration gradient in which more metal ions derived from a metal salt are arranged in a surface direction of the film, the film can substantially obtain an adhesion control effect, although an applied amount of a metal salt compound to be applied for obtaining an adhesion control effect is reduced below the same compared to conventional films, with having substantially enhanced moisture resistance and/or durability, and thus completed this invention.

In one general aspect, a film for glass lamination includes a polyvinyl acetal resin, a plasticizer, and a metal salt, wherein the film has an adhesion control effect of 8.5 kgf/cm² or more per the metal salt in an amount of 10 ppm based on a total weight of the film.

The film for glass lamination may have an uneven concentration gradient of the metal salt such that a surface of the film includes the metal salt or metal ions derived from the metal salt in a higher concentration compared to a center of the film.

When the concentration of metal ions is differently applied depending on a thickness from the surface of the film to the inside, even though a metal salt compound is applied as an adhesion regulator in the same amount as in a conventional film, a film for glass lamination having different adhesive strength depending on the thickness can be provided by allowing the film to have a concentration gradient in which distribution of a metal salt compound, in particular, distribution of a metal cation is concentrated in a surface.

This means that though an additive (including materials derived from this additive) having a sufficient adhesion control effect acts in a surface of the film for glass lamination interacting with a glass to be laminated, in the overall film, the metal salt compound may be used in a comparatively small amount, and thereby an effect of improving moisture sensitivity of the film can also be obtained.

The film for glass lamination may have the metal salt or the metal ions distributed in a greater amount in both surfaces thereof compared to the center of the film.

A graph showing the concentration gradient of the metal salt or the metal ions depending on a depth from a surface of one side to a surface of the other side may have a U shape. When having this concentration gradient, it is possible to distribute the metal salt or the metal ions inside the film for glass lamination in a most efficient configuration.

The U shape does not refers to an absolute U shape, but refers to that the metal ion concentration graph depending on depth has a U shape overall, and means the shape distinguishable from other shapes such as “-” shape, W shape, L shape, M shape, and N shape.

Specifically, the concentration gradient of the metal salt or the metal ions depending on the depth from the surface of the film may be measured using TOF-SIMS (Time-of-Flight Secondary Ion Mass Spectrometry). For example, the TOF-SIMS may be applied by regulating a thickness of the film cut by repeated sputtering as 1 nm, then the concentration gradient of the metal salt or the metal ions may be measured. As a result, the film for glass lamination may have a greater concentration of the metal salt or the metal ions, specifically more than two-folds, at a thickness of 5 to 85 nm than at 105 to 155 nm in terms of an average metal ion concentration per 10 nm thickness of the film.

Additionally, the measured value of metal ion concentration at a thickness from 6 nm to 15 nm may be four times or more greater than that at a thickness from 96 nm to 105 nm of the film for glass lamination. Such concentration distribution shows that the concentration of metal ions at a surface is considerably higher than other portions of the film.

An adhesion control effect of 8.5 kgf/cm² or more, 8.5 to 50 kgf/cm², or 9.5 to 40 kgf/cm² per the metal salt in an amount of 10 ppm based on a total weight of the film may be obtained based on the entire film for glass lamination.

The adhesion control effect refers to regulation of adhesive strength between the surface of the film for glass lamination and a surface of glass and may be evaluated based on CSS (Comprehensive Shear Strength) adhesion test.

The film for glass lamination may have the adhesion control effect of 1.3 times or more, two times or more, or three times or more compared to a reference film not having the above concentration gradient with same other conditions.

Additionally, the film for glass lamination may have an adhesion control effect of four times or more, or two to six times compared to the reference film depending on the strength of an applied voltage.

Because the film for glass lamination has an adhesion control effect in a considerably excellent level even though including the metal salt in a comparatively small amount, disadvantages such as moisture resistance degradation, which can be generated by using the metal salt in an excessive amount, can be substantially reduced and a yellowing resistance characteristic and the like can be enhanced.

The metal salt may be included in an amount of 200 ppm or less, 150 ppm or less, 100 ppm or less, or 1 to 80 ppm based on the total weight of the film.

The metal ions may comprise a divalent metal ion and/or a monovalent metal ion.

The divalent metal ion may be magnesium divalent ion.

The monovalent metal ion may be sodium monovalent ion, potassium monovalent ion, or a combination thereof.

The metal ions may be selected from the group consisting of magnesium divalent ion, potassium monovalent ion, and a combination thereof.

The detailed description on the metal salt overlaps with contents referred in the below description on a composition and thus the further description is omitted.

The film for glass lamination may have an excellent moisture resistance characteristic such that a whitening occurrence distance of the film is 5 mm or less, which is measured from a laminated glass including the film after being kept in a constant temperature and humidity chamber of 65° C. and 95% rh for two weeks.

The film for glass lamination may have a yellowing index variation of 2.5 or less between before and after being kept for two weeks in a chamber having a constant temperature and humidity of 65° C. and 95% rh.

The pummel adhesion grade of a laminated glass comprising the film may be grade 3 or 4.

The thickness of the film for glass lamination may be 0.4 mm or more, 0.4 to 1.6 mm, 0.5 to 1.2 mm, or 0.6 to 0.9 mm. When manufacturing the film to have such a thickness, it is possible to provide a thin and light film having characteristics such as excellent impact resistance and penetration resistance.

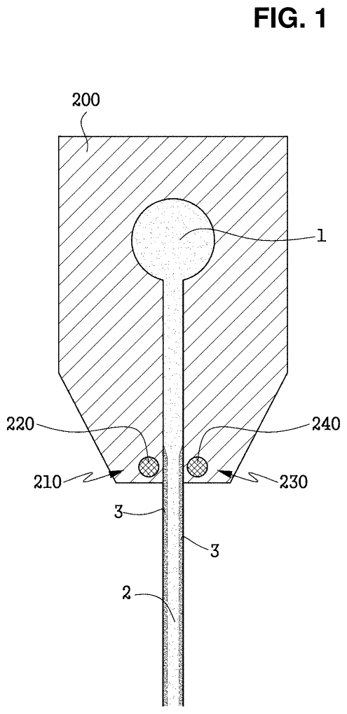

FIG. 1 is a schematic view for illustrating a device structure of a die lip for regulating an ion concentration in a surface of a film according to one embodiment of the present disclosure. Hereinafter, the present disclosure will be described in detail with reference to FIG. 1.

In another general aspect, a method of manufacturing a film for glass lamination includes: preparing a molten resin by melting a composition including a polyvinyl acetal resin, a plasticizer, and a metal salt; and forming the film by applying a voltage to at least a part of a shaping unit for discharging and shaping the molten resin into the film, wherein the film has an adhesion control effect of 8.5 kgf/cm² or more per the metal salt in an amount of 10 ppm based on a total weight of the film.

The film for glass lamination may have an uneven concentration gradient such that the surface of the film includes a metal salt or metal ions derived from the metal salt in a greater concentration compared to the center of the film.

The melting step is for preparing a molten resin by melting a composition including a polyvinyl acetal resin, a plasticizer, and a metal salt. The metal salt may exist inside the film in a state of metal salt or as a metal ion.

A conventional resin melting method such as a method using a twin-screw extruder may be applied in the melting step.

Description regarding the composition including a polyvinyl acetal resin and an additive, and a metal salt comprised in the additive, will be made in detail below.

The shaping step is for forming the film for glass lamination by applying voltage to at least a part of a shaping unit for discharging and shaping the molten resin into a film form.

As for the shaping unit, any one for manufacturing a film form with controlling the thickness can be applied. When manufacturing a monolayer film, a molten resin can be manufactured into a film form by being placed in an extruder (ex. twin-screw extruder), melted and discharged with having a controlled thickness through a T-die, or when manufacturing a multilayer film, a molten resin can be shaped into a film form in a T-die after respectively being melted and discharged in an extruder to be laminated through a laminating device such as a feed block or a multi manifold.

Referring to FIG. 1, a T-die 200 is placed at one end of the shaping unit, the T-die 200 has an inlet (not shown) through which a molten resin composition 1 flows into and an outlet through which the molten resin composition 1 is discharged, and die lips 210 and 230 are placed at both sides of a part for discharging the molten resin composition 1. In one embodiment of the present disclosure, voltage applying parts 220 and 240 are placed at both sides of the die lips 210 and 230. The voltage applying parts 220 and 240, for example, are voltage applying devices like a tungsten wire, which can apply a voltage to the die lips 210 and 230. The voltage applying parts 220 and 240 are electrically connected to an external power supply device (not shown).

The voltage applying parts 220 and 240 regulate the voltage applied to the die lips and allow the molten resin 1 to be a charged molten resin 2. The charged molten resin 2 includes a high-concentration area 3, where the concentration of the metal salt or the metal ions are high, because the metal salt or the metal ions move to a surface. The high-concentration area 3 refers to an area where a surface ion concentration described below is higher than the average ion concentration of a film. The charged molten resin having a high-concentration area in the surface subsequently forms a film for glass lamination having a metal ion concentration gradient of U shape along a thickness direction.

The voltage applied to the voltage applying parts may be 10 kV or less, 1 to 10 kV, 1.5 to 8 kV, or 2.5 to 6 kV. When the voltage is too low, the force for pulling a metal ion, which is cation, to the surface of the film is weak such that a sufficient concentration gradient may not be formed. Also, when the voltage is too high, degradation may occur in a polymer film, and properties of the film may be degraded because the properties such as optical properties and long-term durability is affected.

Specifically, when the molten resin contains the metal salt in an amount of 0.1 to 0.3 wt %, a voltage applied by the voltage applying part may be 4 to 6 kV, and when the molten resin contains the metal salt in an amount of more than 0.3 wt % and 0.8 wt % or less, a voltage may be applied in 3 to 4 kV.

The voltage may be applied such as to pull the metal ion, which is cation, and it may have a negative charge.

The voltage applied in the shaping step may form a high-concentration area in a surface of a molten resin by moving metal ions included in the molten resin to a surface of the discharged molten resin. The range of the high-concentration area and the degree of high concentration may be narrowed or widened within a certain range by regulating the voltage.

The charged molten resin 2 to be shaped in the shaping step is discharged at a rate of 5 to 15 m per minute to be formed into a film for glass lamination, and the rate may be 5 to 15 m, or 7 to 13 m per minute.

After the shaping, conventional processes generally applied in manufacture of a film for glass lamination may be applied, and the detailed description is omitted.

Hereinafter, the polyvinyl acetal resin and the additive added in forming the molten resin will be described.

The polyvinyl acetal may be a polyvinyl acetal obtained by acetalization of a polyvinyl alcohol having a polymerization degree of 1,600 to 3,000 using an aldehyde, or a polyvinyl acetal obtained by acetalization of a polyvinyl alcohol having a polymerization degree of 1,700 to 2,500 using an aldehyde. When such a polyvinyl acetal is applied mechanical properties like penetration resistance can be sufficiently enhanced.

The polyvinyl acetal may be synthesized from a polyvinyl alcohol and an aldehyde, and the aldehyde is not limited in the type. In detail, the aldehyde may be selected from the group consisting of n-butyl aldehyde, isobutyl aldehyde, n-valer aldehyde, 2-ethyl butyl aldehyde, n-hexyl aldehyde, and a blend resin thereof. When n-butyl aldehyde is applied as the aldehyde, a resulting polyvinyl acetal resin may have characteristics of refractive index having low difference with the refractive index of glass and excellent adhesive strength with glass and the like.

The additive includes a plasticizer.

The plasticizer may be selected from the group consisting of triethylene glycol bis 2-ethylhexanoate (3G8), tetraethylene glycol diheptanoate (4G7), triethylene glycol bis 2-ethylbutyrate (3GH), triethylene glycol bis 2-heptanoate (3G7), dibuthoxyethoxyethyl adipate (DBEA), butyl carbitol adipate (DBEEA), dibutyl sebacate (DBS), bis 2-hexyl adipate (DHA), and a mixture thereof, and more specifically, triethylene glycol bis 2-ethylhexanoate (3G8) may be applied as the plasticizer.

The additive includes a metal salt compound.

The metal salt compound is applied for obtaining an adhesion control effect, and specifically, a metal salt of carboxyl acid having two to sixteen carbon atoms may be applied, and more specifically, a metal salt of a divalent metal having two to twelve carbon atoms, or a metal salt of a monovalent metal having two to six carbon atoms may be applied.

The metal ion included in the metal salt compound may be selected from the group consisting of sodium (Na) monovalent cation, magnesium (Mg) divalent cation, and potassium (K) monovalent cation.

The metal salt may be applied as an intact metal salt compound or an ionized state dissolved in a solvent, and serves as an adhesion regulator. In detail, it can regulate adhesive strength of a film and a surface of glass. When the metal salt is applied as a solution, the metal salt compound or ions derived from the metal salt may disperse more easily and move inside a manufactured film or an adhesion layer.

The metal salt may be included in an amount of 200 ppm or less, 150 ppm or less, 100 ppm or less, or 1 to 80 ppm based on the molten resin. The ppm is based on weight.

The molten resin may include a monolayer film, or a surface layer of a multilayer film.

The metal salt compound may be included in an amount described in the above based on the entire composition, thereby manufacturing the film for glass lamination, which is a monolayer or a multilayer. In case of the multilayer, a surface layer (adhesion layer) of the multilayer film may be formed with the composition including the metal salt compound.

A polyvinyl acetal resin composition may include a UV stabilizer (UV absorber) for enhancing a UV blocking effect, and a benzotriazole-based compound may be included as a UV stabilizer.

The benzotriazole-based compound may have a variation of bond structure by an interaction between a hydroxyl group of the molecule and a nitrogen included in a triazole ring located near the hydroxyl group. Therefore, if a metal ion gets involved in the interaction, the effect as a UV stabilizer of the benzotriazole-based compound may be degraded. Also, the benzotriazole-based compound may form a chelate ring by a coordinate covalent bond with a polyvalent metal ion, and the benzotriazole-based compound having the chelate ring formed therein in this manner may not sufficiently function as a UV stabilizer, thereby weakening durability of the entire film.

As the UV stabilizer, a conventional UV stabilizer may be applied without limit, and a UV stabilizer including a benzotriazole-based compound is also applicable. Specifically, Chemisorb 12, Chemisorb 79, Chemisorb 74, or Chemisorb 102 available from CHEMIPRO KASEI KAISHA, LTD may be used, or Tinuvin 328, Tinuvin 329, or Tinuvin 326 available from BASF SE may be used.

The present disclosure allows even a small amount of benzotriazole-based compound to have an excellent adhesion control effect, and to function as a UV stabilizer sufficiently, thereby enhances durability of the film for glass lamination itself.

The metal salt compound may be included in an amount of 16 parts by weight or less, 12 parts by weight or less, or 1 to 10 parts by weight based on the benzotriazole-based compound of 100 parts by weight. When the metal salt compound is included in an amount of less than 1 parts by weight based on the benzotriazole-based compound of 100 parts by weight, an adhesion control effect obtained by adding the metal salt compound may not be sufficient, and when the metal salt compound is included in an amount of more than 16 parts by weight, moisture resistance may be degraded instead.

The composition may further include an additive selected from the group consisting of an antioxidant, a heat stabilizer, an IR absorber, and a combination thereof as required. The additive may be included in at least one layer among respective layers in the above or may be included in the entire film.

Long term durability such as thermal stability and light stability, and anti-scattering performance of the film may be further improved by including the additive to the composition.

As the antioxidant, a hindered amine-based antioxidant or a hindered phenol-based antioxidant may be used. Specifically, on the process of manufacturing polyvinyl butyral (PVB) which needs a processing temperature of 150° C. or higher, a hindered phenol-based antioxidant is preferred. The hindered phenol-based antioxidant, for example, may be Irganox 1976, 1010, or so on available from BASF SE.

As the heat stabilizer, a phosphite-based heat stabilizer may be used considering suitability with the antioxidant. The heat stabilizer, for example, may be Irgafos 168 available from BASF SE. As the IR absorber, ITO, ATO, or AZO may be used, but the present application is not limited thereto.

In another general aspect, a laminated glass includes the film for glass lamination disposed between two glasses.

The two glasses are described as only an example, and any light transmission panel is applicable, thus a material such as plastic may also be applied.

Descriptions on the detailed structure, composition, characteristics, method of manufacture and so on are overlapped with the above description and thus further description is omitted.

The laminated glass may have an average whitening occurrence distance of 5 mm or less, 0 to 5 mm, or 0.1 to 5 mm measured by keeping a sample having an area of 100 mm×100 mm for two weeks in a constant temperature and humidity chamber at 65° C. and 95% rh. Such an average whitening occurrence distance means having a considerably excellent moisture resistance even in a condition of high temperature and humidity.

The laminated glass may have a yellowing index variation of 2.5 or less between before and after being kept for two weeks in a constant temperature and humidity chamber at 65° C. and 95% rh. This shows that the laminated glass has excellent long-term durability. Especially, considering that the film may include both of a benzotriazole-based compound and a metal salt, the range of the yellowing index variation described above is surprising and excellent result.

A CSS adhesion of the laminated glass may be 160 to 320 kgf/cm², or 160 to 280 kgf/cm². This is a proper range of an adhesive strength between a glass and a film and means that it has a sufficient adhesive strength for functioning as a safety glass.

Hereinafter, the present disclosure will be described in further detail by specific embodiments. The below embodiments are for illustration only and the scope of the present application is not limited thereto.

1. Preparation of Materials

1) Preparation of Additive Compositions

Irganox 1010 as an antioxidant of 0.15 wt % based on the entire film, Tinuvin P as a UV absorber of 0.3 wt %, magnesium acetate (Mg acetate) as a metal salt adhesion regulator of 0.15 wt %, and potassium acetate (K acetate) as a metal salt adhesion regulator of 0.13 wt % were mixed into additive composition 1.

Irganox 1010 as an antioxidant of 0.15 wt % based on the entire film, Tinuvin P as a UV absorber of 0.3 wt %, and potassium acetate (K acetate) as a metal salt adhesion regulator of 0.56 wt % were mixed into additive composition 2.

Irganox 1010 as an antioxidant of 0.15 wt % based on the entire film, Tinuvin P as a UV absorber of 0.3 wt %, magnesium acetate (Mg acetate) as a metal salt adhesion regulator of 0.45 wt %, and potassium acetate (K acetate) as a metal salt adhesion regulator of 0.38 wt % were mixed into additive composition 3.

2) Preparation of Polyvinyl Butyral Resin (A)

A polyvinyl acetal resin having a polymerization degree of 1700 and a saponification degree of 99 and n-butanal were put into a reactor for a general synthesis process of a polyvinyl butyral resin to proceed and thereby a polyvinyl butyral resin having a hydroxyl group of 20.1 wt %, a butyral group of 79.2 wt %, and an acetyl of 0.7 wt % was obtained.

2. Preparation of Polyvinyl Butyral Films

1) Setting for Manufacture of a Film of Examples

A device in a specific form having tungsten wires 220 and 240 available from VWF INDUSTRIES equipped in die lip parts 210 and 230 was used for regulating ion concentration of a surface of a film.

Both ends of the tungsten wires 220 and 240 are connected to an electric generator to apply voltage to the tungsten wires, and (+) or (−) charges can be applied to the wires depending on the mode of the electric generator by selecting POSITIVE or NEGATIVE. In the present disclosure, NEGATIVE mode was selected and used to control concentration distribution of metal ions in Examples (refer to FIG. 1).

2) Preparation of Films of Examples 1 to 4

Polyvinyl butyral resin (A) of 72.27 wt %, 3G8 as a plasticizer of 27 wt %, and additive composition 1 as an additive of 0.73 wt % were put into a twin-screw extruder, melted and extruded to manufacture a film form with a total thickness of 760 μm at a rate of 10 M per minute through a T-die set described the above. At this time, the applied electric current was changed in a range of 1 to 6 kV (refer to table 1).

3) Preparation of a Film of Comparative Example 1

Though a film was manufactured by the same as Example 1, the film was manufactured with no voltage applied, thereby manufacturing a film of Comparative Example 1.

4) Preparation of a Film of Comparative Example 2

Polyvinyl butyral resin (A) of 71.99 wt %, 3G8 as a plasticizer of 27 wt %, and additive composition 2 of 1.01 wt % were put into a twin-screw extruder and extruded to manufacture a film form with a total thickness of 760 μm at a rate of 10 M per minute through a T-die. Voltage was not applied as Comparative Example 1.

5) Preparation of a Film of Comparative Example 3

Polyvinyl butyral resin (A) of 71.72 wt %, 3G8 as a plasticizer of 27 wt %, and additive composition 3 of 1.28 wt % were put into a twin-screw extruder and extruded to manufacture a film form with a total thickness of 760 μm at a rate of 10 M per minute through a T-die. A process for applying voltage was not used as Comparative Example 1.

6) Preparation of a CSS Reference Sample

Polyvinyl butyral resin (A) of 73 wt % and 3G8 as a plasticizer of 27 wt % were put into a twin-screw extruder and extruded to manufacture a film form with a total thickness of 760 μm at a rate of 10 M per minute through a T-die. This sample was applied as a CSS value reference sample in CSS adhesion evaluation.

3. Property Evaluation of Polyvinyl Butyral Films

1) Preparation of Samples for Durability/Moisture Resistance Evaluation

Films of Examples 1 to 4 and Comparative Examples 1 to 3 were kept for a week at 20° C. and 30% RH, and then cut into a size of 100 mm×100 mm (width×length), and two pieces of clear glass of 2.1 T (mm, same as below) were placed at both sides thereof to prepare a laminated structure of 2.1 T glass—film—2.1 T glass. Pre-laminating of the laminated structure was performed for 20 seconds in a vacuum laminator at 120° C. and 1 atmospheric pressure.

Thereafter, main laminating of the pre-laminated laminated structure of glass—film—glass was performed thereby obtaining laminated glass samples. Heating time for 25 minutes from room temperature to 140° C. and maintaining time for 25 minutes at 140° C. were used as the condition for the main laminating.

2) A Method of Evaluating Yellowing Index Variation (d-YI)

Initial values of yellowing index (YIᵢₙᵢₜᵢₐₗ) at the center of the laminated glass samples manufactured as above were measured by using Ultra Scan Pro available from HUNTERLAB under the condition of D65 and 10 degrees according to ASTM E313 standard. Samples whose initial values of yellowing index had been measured were kept for two weeks in a constant temperature and humidity chamber at 65° C. and 95% rh, taken out and measured again by the same method as above for measuring final values of yellowing index (YI_{final}), such that the difference of yellowing index was calculated by following Equation 2.

d−YI=YI_{final}−YIᵢₙᵢₜᵢₐₗ [Equation 2]

When a value obtained by the Equation 2 was 2.5 or less, it was evaluated as Pass, and when a value obtained by the Equation 2 was more than 2.5, it was evaluated as Fail.

3) Moisture Resistance Evaluation: Measurement for Whitening Occurrence Distance

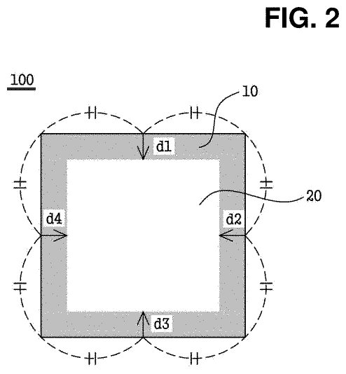

The laminated glass samples 100 manufactured as above were kept for two weeks in a constant temperature and humidity chamber at 65° C. and 95% rh and taken out for checking with naked eyes a part 10 (the area where a whitening phenomenon occurred), where haze occurred, from the center of four sides, the distance was measured with a ruler (refer to FIG. 2), and the average value of four sides was calculated according to below Equation 3 to obtain a whitening occurrence distance (mm).

Average Whitening Distance=(d1+d2+d3+d4)+4 [Equation 3]

On the Equation 3, the distances where a whitening phenomenon occurred were measured at the center of first to fourth sides and respectively, and referred to as d1 to d4 (mm as the unit).

When the average whitening occurrence distance is 5 mm or less, it was evaluated as Pass, and when the average whitening occurrence distance is more than 5 mm, it was evaluated as Fail.

4) CSS Adhesion Evaluation

Adhesion between a polyvinyl acetal film and glass was evaluated through CSS (Compressive Shear Strength) adhesion evaluation.

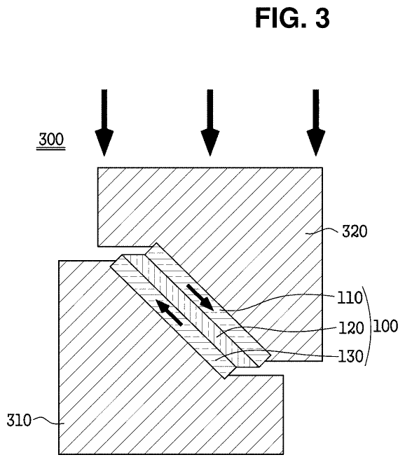

The method of measurement will be described with reference to FIG. 3. PVB films 120 manufactured according to the Examples and Comparative Examples, and a CSS reference sample 120 were cut in a size of 300 mm×300 mm in the center based on a width direction, and were kept for a week at 20° C. and 20% RH to perform a conditioning thereof. Two pieces of clear glass 110 and 130 of 2.1 T were placed at both sides of the film, and then the laminate having a laminated structure of 2.1 T glass—film—2.1 T glass with a size of 50 mm×150 mm (width×length) was pre-laminated for 50 seconds in a vacuum laminator under 150° C. and 1 atmospheric pressure. Thereafter, main lamination was performed with heating time for 25 minutes from room temperature to 140° C. and maintaining time for 25 minutes at 140° C., thereby obtaining laminated glass samples 100.

The samples manufactured as a laminated glass were kept for one hour at 20° C. and 20% RH, thereby removing heat, and manufactured into samples for CSS evaluation that were cut into a circle shape with a diameter of 1 inch (25.4 mm) using a boring machine. The samples for evaluation were kept for 2 hours at 20° C. and 20% RH for conditioning thereof and taken out, and then equipped in jigs for CSS (holder 310 and 320), which was tilted by 45 degrees for compression test proceeding at a rate of 2.54 mm per minute using a universal testing machine (UTM), such that a value of force (kgf) at a point, at which the force became the maximum in samples, was measured. As for measurement, repetitive tests of five times per one sample were performed to get an average value of three values except for the highest and lowest values, and the average value was shown as CSS adhesion (refer to Table 1).

5) Calculation of an Adhesion Control Effect

An adhesion control effect per a metal salt in an amount of 10 ppm was calculated by below Equation 1 with CSS adhesion calculated as above 4).

$${CP}_{10} = ( \frac{SS - TS}{{C}_{m}} ) \times 10 \qquad [ Equation 1 ]$$

In the Equation 1, the CP₁₀ is a CSS adhesion control effect per a metal salt in an amount of 10 ppm, the SS is a CSS value of a CSS reference sample, the TS is a CSS measured value of Examples or Comparative Examples, and the Cm is an input (ppm) of a metal salt.

TABLE 1

| | | Comparative | Example | Example | Example | Example | Comparative | Comparative |
|---|---|---|---|---|---|---|---|---|
| | | Example1 | 1 | 2 | 3 | 4 | Example2 | Example3 |
| Input of | Mg Acetate | 25 | 25 | 25 | 25 | 25 | 0 | 75 |
| Metal Salt | K Acetate | 50 | 50 | 50 | 50 | 50 | 225 | 150 |
| (ppm) | TOTAL | 75 | 75 | 75 | 75 | 75 | 225 | 225 |
| Applied Voltage (KV) | | n/a | 1 | 2 | 5 | 6 | n/a | n/a |
| Evaluation | CSS | 341.4 | 319.7 | 260.5 | 169.7 | 163.8 | 236.8 | 232.9 |
| | Adhesion | | | | | | | |
| | (kgf/cm²) | | | | | | | |
| | Adhesion | 55.3 | 77 | 136.2 | 227 | 232.9 | 159.9 | 163.8 |
| | Variation | | | | | | | |
| | (Δkgf/cm²) | | | | | | | |
| | CSS | 7.1 | 10 | 17.9 | 30 | 30.8 | 7 | 7.2 |
| | Adhesion | | | | | | | |
| | control | | | | | | | |
| | effect per | | | | | | | |
| | 10 ppm | | | | | | | |
| | (kgf/cm² | | | | | | | |
| | per 10 ppm) | | | | | | | |
| | Increase | — | 141% | 252% | 423% | 434% | — | — |
| | Rate of | | | | | | | |
| | Adhesion | | | | | | | |
| | control | | | | | | | |
| | effect * | | | | | | | |
| | Moisture | Pass | Pass | Pass | Pass | Pass | Fail | Fail |
| | Resistance | | | | | | | |
| | Durability | Pass | Pass | Pass | Pass | Pass | Fail | Fail |

* Increase Rate of Adhesion control effect refers to values shown as percentage with ratios of values of CSS adhesion control effect per 10 ppm of Examples 1 to 4 based on a value of CSS adhesion control effect per 10 ppm of Comparative Example 1.

Referring to Comparative Example 1, and Examples 1 to 4 of Table 1, it could be confirmed that the CSS adhesion of the film including the same metal salt in the same amount was decreased as the applied voltage increases. It could be confirmed that Examples 4 and 5 applied with a voltage of 5 or 6 kgV had similar or more regulated adhesion values compared to Comparative Examples 2 and 3 applied with the metal salt of about three times amount.

Furthermore, the CSS adhesion control effect was also shown to increase as the applied voltage increases, but a degree of increase was decreased as the voltage was increased from 5 V to 6 V.

Referring to the results of Table 1, the film can achieve the same or more adhesion control effect even including a smaller amount of the metal salt compared to conventional films. Therefore, the film of the present disclosure can substantially prevent durability degradation and/or moisture resistance degradation, which can be generated as problems when a large amount of metal salt is used. At the same time, the film can achieve a sufficient adhesion control effect.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A film for glass lamination comprising a polyvinyl acetal resin, a plasticizer, and a metal salt, wherein the film has an adhesion control effect of 8.5 kgf/cm² or more per the metal salt in an amount of 10 ppm based on a total weight of the film.

2. The film of claim 1, wherein the film has the adhesion control effect of 8.5 to 50 kgf/cm² per the metal salt in an amount of 10 ppm based on the total weight of the film.

3. The film of claim 1, wherein the film has an uneven concentration gradient of the metal salt such that a surface of the film comprises the metal salt or metal ions derived from the metal salt in a higher concentration compared to a center of the film.

4. The film of claim 1, wherein the film has an adhesion control effect of 1.3 times greater compared to a reference film not having the uneven concentration gradient of the metal salt.

5. The film of claim 3, wherein the film contains a greater amount of the metal salt or the metal ions in both surfaces of the film compared to the center of the film.

6. The film of claim 1, wherein the metal salt is comprised in an amount of 200 ppm or less based on the total weight of the film.

7. The film of claim 1, wherein the metal ion comprised in the metal salt may be selected from the group consisting of sodium (Na) monovalent cation, magnesium (Mg) divalent cation, and potassium (K) monovalent cation.

8. The film of claim 1, wherein the metal salt is a benzotriazole-based compound.

9. The film of claim 1, wherein the film has a yellowing index variation of 2.5 or less between before and after being kept for two weeks in chamber having a constant temperature and humidity of 65° C. and 95% rh.

10. The film of claim 1, wherein the film has a thickness of 0.4 mm or more.

11. A method of manufacturing a film for glass lamination comprising:
preparing a molten resin by melting a composition including a polyvinyl acetal resin, a plasticizer, and a metal salt; and
forming the film by applying a voltage to at least a part of a shaping unit for discharging and shaping the molten resin into the film,
wherein the film has an adhesion control effect of 8.5 kgf/cm² or more per the metal salt in an amount of 10 ppm based on a total weight of the film.

12. The method of claim 11, wherein the film has the adhesion control effect of 8.5 to 50 kgf/cm² per the metal salt in an amount of 10 ppm based on the total weight of the film.

13. The method of claim 11, wherein the film has an uneven concentration gradient of the metal salt such that a surface of the film comprises the metal salt or metal ions derived from the metal salt in a higher concentration compared to a center of the film.

14. The method of claim 11, wherein the metal salt may be comprised in an amount of 200 ppm or less based on the total weight of the film.

15. The method of claim 11, wherein the metal ion comprised in the metal salt may be selected from the group consisting of sodium (Na) monovalent cation, magnesium (Mg) divalent cation, and potassium (K) monovalent cation.

16. The method of claim 11, wherein the metal salt is a benzotriazole-based compound.

17. The method of claim 11, wherein the voltage applied is 8 kV or less.

18. The method of claim 11, wherein the shaping unit comprises an outlet, die lips in both sides of the outlet, and a voltage applying part disposed in the die lips.

19. The method of claim 13, wherein the voltage applied in the forming moves the metal ions comprised in the molten resin to a surface of a discharged molten resin and thereby forms the uneven concentration gradient of the metal salt.

20. A laminate comprising the film for glass lamination of claim 1 disposed between two glasses.
